(19) United States
(12) Patent Application Publication
(10) Pub. No.: US 2012/0181989 A1
(43) Pub. Date: Jul. 19, 2012

(54) ELECTRIC ENERGY GENERATING APPARATUS AND MOBILE ELECTRIC DEVICE THEREOF

(75) Inventors: HUI-FANG LI, Shanghai City (CN); BING-HAO FAN, Shanghai City (CN); TONY TSAI, Shanghai City (CN)

(73) Assignees: INVENTEC APPLIANCES (SHANGHAI) CO. LTD., Shanghai (CN); INVENTEC APPLIANCES CORP., SHANGHAI, Shanghai City (CN); INVENTEC APPLIANCES CORP., Taipei County (TW)

(21) Appl. No.: 13/009,336

(22) Filed: Jan. 19, 2011

(51) Int. Cl. H02J 7/14; F03G 7/08

(52) U.S. Cl. 320/137; 290/1 C

(57) ABSTRACT

An electric energy generating apparatus and a mobile electronic device equipped with the electric energy generating apparatus are disclosed. The electric energy generating apparatus includes a kinetic energy generating module, a kinetic energy transmission module, an electric generator and a voltage regulation module. The kinetic energy generating module is provided for generating kinetic energy; the kinetic energy transmission module is provided for transmitting the kinetic energy generated by the kinetic energy generating module to the electric generator; the electric generator is provided for converting the kinetic energy into electric energy; and the voltage regulation module is provided for regulating and outputting a voltage. The invention can convert the kinetic energy into the electric energy anytime and anywhere to overcome the problems of running out of battery power or resulting in a failure of operating the mobile electronic device and provide an easily accessible green power source from man power.

### BACKGROUND OF THE INVENTION

1. Field of the Invention

The present invention relates to a power source of an electronic device, and more particularly to an apparatus for converting kinetic energy into electric energy and a mobile electronic device using the apparatus.

2. Description of the Related Art

As portable or mobile electronic devices such as mobile phones, personal digital assistants (PDAs), and MP3/MP4 players become increasingly popular, the scope of their applications becomes larger and larger, so that the limited battery capacity of the electronic devices cannot meet the actual requirements. After the electric power of a battery is exhausted, it is necessary to charge the battery of the electronic devices before the electronic devices can be used normally. In an environment without a battery charge such as a country side without any power source, an opportunity of seeking help in an emergency situation or a business opportunity may be lost if a mobile phone used for communications runs out battery.

Present existing technology used for overcome the aforementioned problem usually increases the capacity of the battery to extend the idling time or rescue the power consumption of the electronic device, or carry as many backup batteries as possible, but such measures cannot overcome the problems thoroughly.

### SUMMARY OF THE INVENTION

Therefore, it is a primary objective of the present invention to overcome the aforementioned shortcomings of the prior art by providing an apparatus for converting kinetic energy into electric energy, such that kinetic energy can be collected and converted into electric energy anytime and anywhere to supply electric power to a portable or mobile electronic device for its use or for a battery charge.

The present invention further provides a mobile electronic device using the aforementioned electronic energy generating apparatus.

To achieve the foregoing objective, the present invention discloses an electric energy generating apparatus, comprising a kinetic energy generating module, a kinetic energy transmission module, an electric generator and a voltage regulation module. The kinetic energy generating module is provided for generating kinetic energy. The kinetic energy transmission module is provided for converting the kinetic energy generated by the kinetic energy generating module to the electric generator. The electric generator is provided for converting the kinetic energy into electric energy. The voltage regulation module is provided for regulating the voltage and outputting the regulated voltage.

Preferably, the kinetic energy transmission module comprises an active gear, a passive gear and a transmission mechanism for transmitting a motion of the active gear to the passive gear. The active gear and the kinetic energy generating module are coaxially fixed, and the passive gear and a rotor of the electric generator are coaxially fixed.

Preferably, the kinetic energy generating module is a pendulum with an end coaxially fixed with the active gear of the kinetic energy transmission module, and the other end suspended and swung with respect to the fixed end to generate a kinetic energy.

Preferably, the transmission mechanism comprises at least one transmission gear, and the passive gear is rotated in a direction determined by the number of the transmission gears, and the rotor of the electric generator is rotated at a speed determined by the size of the active gear, the transmission gear and the passive gear. Thus, when the pendulum swings in a direction, an even number of the transmission gears is used for transmitting the kinetic energy, so that the active gear and the passive gear are rotated in the same direction, and when the pendulum swings in the other direction, an odd number of the transmission gears is used for transmitting the kinetic energy, so that the active gear and the passive gear are rotated in opposite directions.

Preferably, the electric energy generating apparatus further comprises a power management module for controlling components connected to the output terminal of the voltage regulation module. Thus, when a battery of the electronic device requires a battery charge, the output terminal of the voltage regulation module is connected to an electrode of the battery, and when the electronic device requires a power supply for its operation, the output terminal of the voltage regulation module is connected to the input terminal of the power source of the electronic device.

A mobile electronic device in accordance with another preferred embodiment of the present invention is further disclosed, and the electronic device is equipped with an electric energy generating apparatus. The electric energy generating apparatus comprises a kinetic energy generating module, a kinetic energy transmission module, an electric generator and a voltage regulation module. The kinetic energy generating module is provided for generating kinetic energy. The kinetic energy transmission module is provided for transmitting the kinetic energy generated by the kinetic energy generating module to the electric generator. The electric generator is provided for converting the kinetic energy into electric energy. The voltage regulation module is provided for regulating the voltage and outputting the regulated voltage.

Preferably, the kinetic energy transmission module comprises an active gear, a passive gear and a transmission mechanism for transmitting a motion of the active gear to the passive gear. The active gear and the kinetic energy generating module are coaxially fixed, and the passive gear and a rotor of the electric generator are coaxially fixed.

Preferably, the kinetic energy generating module is a pendulum with an end coaxially fixed with the active gear of the kinetic energy transmission module, and the other end suspended and swung with respect to the fixed end to generate a kinetic energy.

Preferably, the transmission mechanism comprises at least one transmission gear.

Preferably, the passive gear is rotated in a direction determined by the number of the transmission gears, and the rotor of the electric generator is rotated at a speed determined by the size of the active gear, the transmission gear and the passive gear. Thus, when the pendulum swings in a direction, an even number of the transmission gears is used for transmitting the kinetic energy, so that the active gear and the passive gear are rotated in the same direction, and when the pendulum swings in the other direction, an odd number of the transmission gears is used for transmitting the kinetic energy, so that the active gear and the passive gear are rotated in opposite directions.

Preferably, the transmission mechanism comprises a belt.

Preferably, the electric energy generating apparatus further comprises a power management module for controlling components connected to the output terminal of the voltage regulation module. Thus, when a battery of the electronic device requires a battery charge, the output terminal of the voltage regulation module is connected to an electrode of the battery, and when the electronic device requires a power supply for its operation, the output terminal of the voltage regulation module is connected to the input terminal of the power source of the electronic device.

Preferably, the electronic device is a mobile phone, and the voltage regulation module has an output voltage value of 5 volts.

Compared with the prior art, the present invention has the following advantages:

The present invention can collect and convert kinetic energy into electric energy anytime and anywhere to thoroughly overcome the problems of the mobile electronic device that cannot be operated normally due to the exhaustion of the battery.

In addition, the present invention provides a green power source supplied by human power.

In addition, the present invention can collect energy easily, and the electric energy can be generated without being limited by the environmental factors.

### BRIEF DESCRIPTION OF THE DRAWINGS

FIG. 1 is a block diagram of an apparatus for converting kinetic energy into electric energy in accordance with a first preferred embodiment of the present invention;

FIG. 2 is a block diagram of an apparatus for converting kinetic energy into electric energy in accordance with a second preferred embodiment of the present invention;

FIG. 3-a is a schematic structural diagram of gear transmission module for rotation in the same direction in accordance with the present invention;

FIG. 3-b is a schematic structural diagram of gear transmission module for rotation in opposite directions in accordance with the present invention;

FIG. 4-a is a schematic structural diagram of a mobile phone in accordance with a first preferred embodiment of the present invention; and

FIG. 4-b is a schematic structural diagram of a mobile phone in accordance with a second preferred embodiment of the present invention.

### DETAILED DESCRIPTION OF THE PREFERRED EMBODIMENTS

The foregoing and other objectives, characteristics and advantages of the present invention will become apparent by the detailed description of a preferred embodiment as follows.

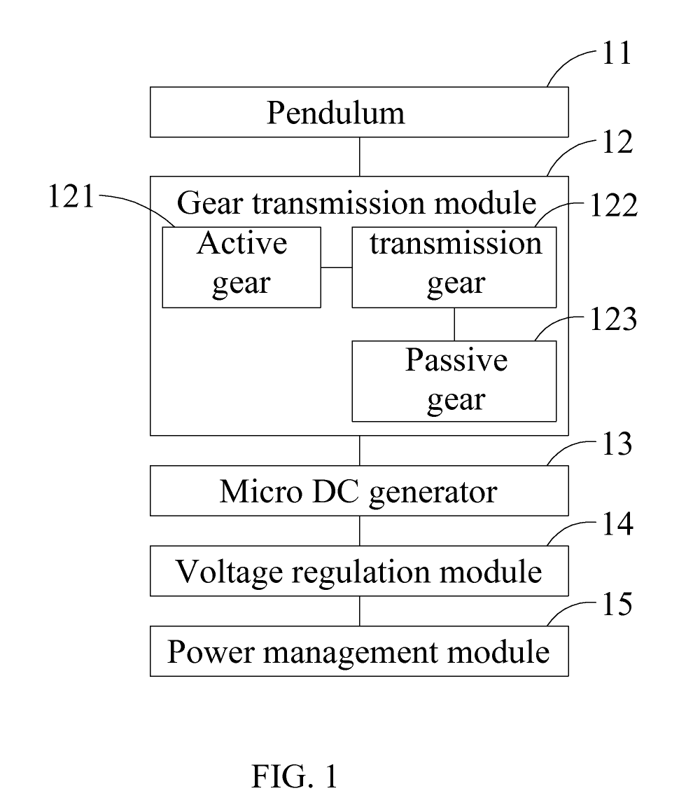

With reference to FIG. 1 for a block diagram of an apparatus for converting kinetic energy into electric energy in accordance with a first preferred embodiment of the present invention, the apparatus comprises the following modules:

Module 11: It is a pendulum with a structure including a fixed end, and a suspending end with larger mass. The pendulum is drooped vertically by the gravitation when it is in a still state. The suspending end swings with respect to the fixed end to generate kinetic energy.

If a user carrying an electronic device equipped with the electric energy generating apparatus is walking or shaking the electronic device, the pendulum will swing sideway by the kinetic energy in different directions as well as the gravitational force, without requiring the user of the electronic device to operate the electric energy generating apparatus in order to generate kinetic energy.

Module 12: It is a gear transmission module for transmitting the kinetic energy generated by the pendulum 11 to a micro electric generator 13. Thus, the kinetic energy can be converted into electric energy by the micro electric generator 13.

The gear transmission module 12 is formed by a plurality of gears with different sizes engaged with each other. Preferably, the gear transmission module 12 comprises an active gear 121, a plurality of transmission gears 122 and a passive gear 123, wherein the active gear 121 and the fixed end of the pendulum 11 are coaxially fixed, and the passive gear 123 and a rotor of the micro electric generator 13, which is a micro DC generator, are coaxially fixed.

When the pendulum 11 swings sideway, it drives the active gear 121 to rotate, and the engaged transmission gear 122 drives the passive gear 123 coaxially fixed with the rotor of the micro electric generator 13 to rotate.

In addition, the rotor of the micro electric generator 13 is rotated at a speed controlled by the size of the active gear 121, the transmission gear 122 and the passive gear 123.

Since the active gear 121 is rotated in the opposite direction when the pendulum 11 swings sideway, a direction changing mechanism is installed to assure the rotor of the micro electric generator 13 is rotated in a direction. The gear direction changing method is described as follows.

When an odd number of the transmission gears is added between the active gear and the passive gear, then the active gear and the passive gear are rotated in the same direction. When an even number of transmission gears is added, then the active gear and the passive gear are rotated in opposite directions. Therefore, a slide slot (not shown) is additional formed on a fixed axle of the transmission gear directly engaged with the active gear. Thus, when the pendulum swings sideway, the transmission gear is driven to move in the slide slot to engage different gears.

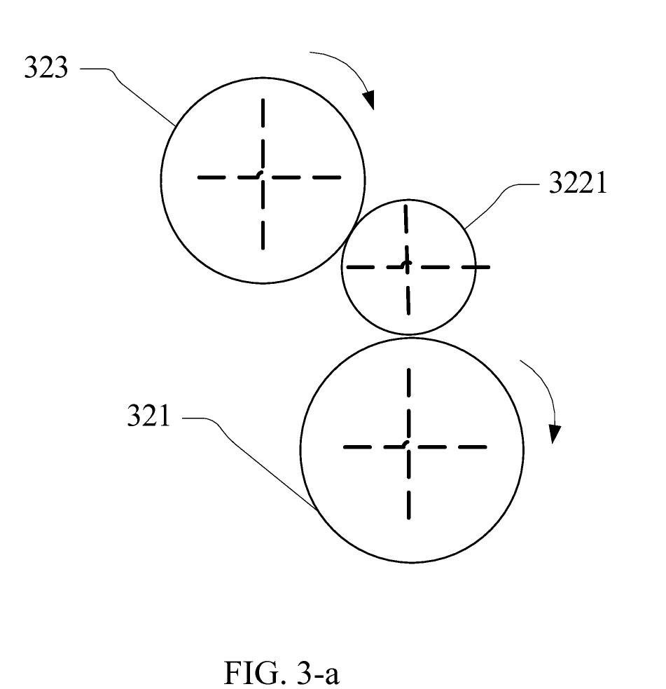

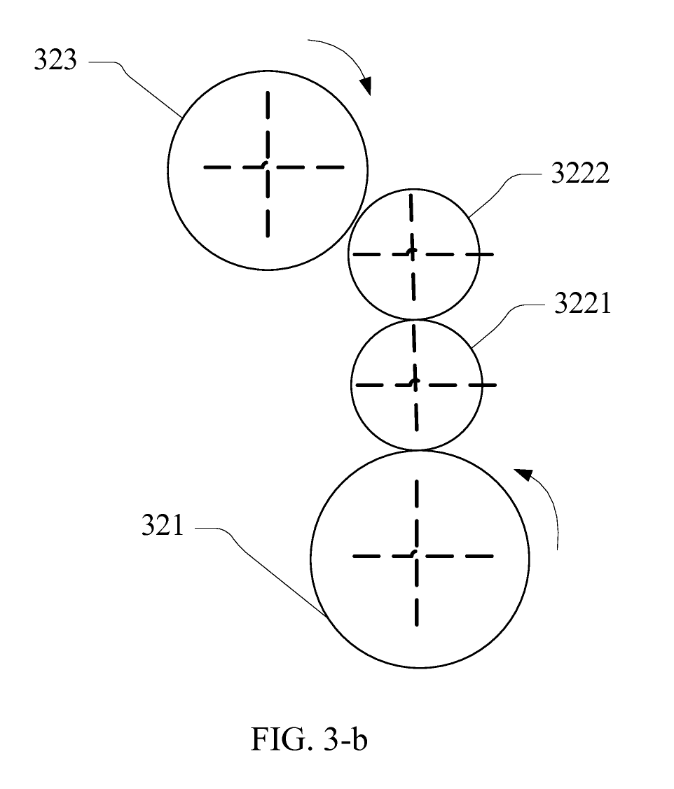

With reference to FIG. 3-a, a transmission gear 3221 is added between the active gear 321 and the passive gear 323, so that the active gear 321 and the passive gear 323 are rotated in one direction (which is clockwise as shown in the figure).

With reference to FIG. 3-b, two transmission gear 3221, 3222 are added between the active gear 321 and the passive gear 323, so that the active gear 321 and the passive gear 323 are rotated in opposite directions (wherein the active gear 321 is rotated counterclockwise and the passive gear 323 is still rotated clockwise).

If the pendulum rotates clockwise (or swings to the left side), the active gear 321 is driven to rotate clockwise. Now, the transmission gear 3221 engaged with the active gear 321 is directly engaged with the passive gear 323 to drive the passive gear 323 to rotate clockwise.

If the pendulum rotates counterclockwise (or swings to the right side), the active gear 321 is driven to rotate counterclockwise. Now, the transmission gear 3221 engaged with the active gear 321 slides in the slide slot to release the engagement with the passive gear 323, and the transmission gear 3221 is engaged with the second transmission gear 3222 and then engaged with the passive gear 323 to drive the passive gear 323 to rotate clockwise.

It is noteworthy to point out that the change of directions can be achieved by using a belt, a clutch or a screw, in addition to the aforementioned method of changing a direction by the gear.

Module 13: It is a micro electric generator for converting the kinetic energy generated by the pendulum 11 into electric energy. An output terminal of the micro electric generator is coupled to an input terminal of the voltage regulation module 14 by a conductive wire.

Since the passive gear 123 of the gear transmission module 12 and the rotor of the micro electric generator 13 are coaxially fixed, therefore an axle of the micro electric generator 13 is driven to rotate when the gear transmission module 12 is rotated. In other words, the gear transmission module 12 can transmit the kinetic energy to the micro electric generator 13, and the rotor of the micro electric generator 13 is rotated to generate electric energy, and the electric energy is outputted to the voltage regulation module 14.

Module 14: It is a voltage regulation module comprised of corresponding basic electronic components such as inductors, capacitors, diodes and triodes and provided for receiving and storing electric energy generated by the micro electric generator 13.

In another preferred embodiment of the present invention, the voltage regulation module 14 generates a constant voltage such as 5V and supplies the voltage to an electronic device such as the mobile phone for a battery charge.

Module 15: It is a power management module for controlling the battery charge of an electric energy generating apparatus of an electronic device or directly supplying electric power to the electronic device for its operation. When the battery level is low and insufficient to support the required power supply of the electronic device, the output terminal of the voltage regulation module 14 is connected to a power input terminal of the electronic device.

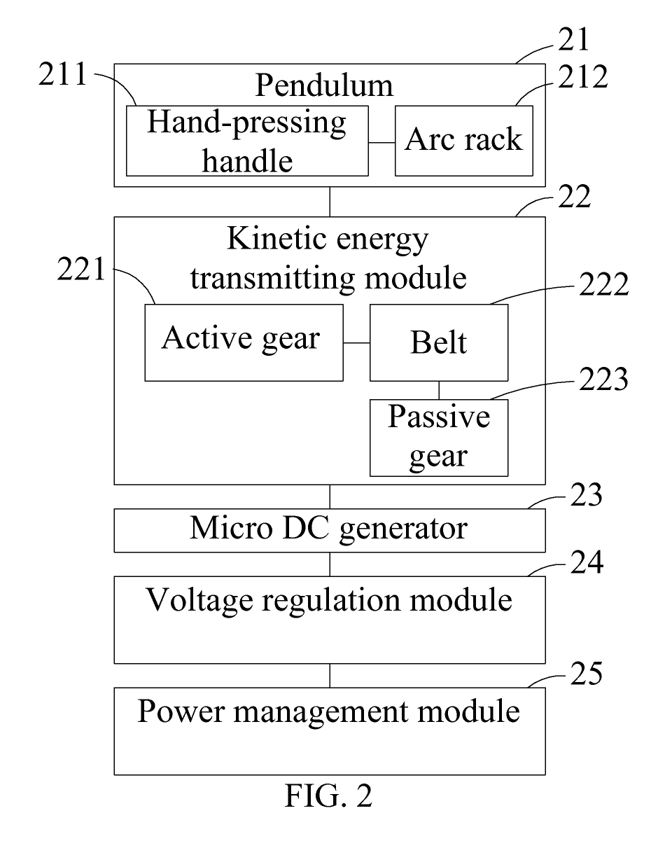

With reference to FIG. 2 for a block diagram of an apparatus for converting kinetic energy into electric energy in accordance with a second preferred embodiment of the present invention, the apparatus comprises the following modules:

Module 21: It is a kinetic energy generating module for generating kinetic energy and comprises a hand-pressing handle 211 and an arc rack 212, wherein an end of the hand-pressing handle 211 is fixed to an end of the arc rack 212, and the arc rack 212 is engaged with the active gear 221 of the gear transmission module 22.

The hand-pressing handle 211 can be moved up and down to drive the arc rack 212 to move up and down to generate kinetic energy.

Module 22: It is a kinetic energy transmitting module for transmitting the kinetic energy generated by the kinetic energy generating module 21 to a micro electric generator 23 and then converting the kinetic energy into electric energy.

When the hand-pressing handle 211 drives the arc rack 212 to move up and down, the engaged active gear 221 will be rotated accordingly. The belt 222 connected to the active gear 221 and the passive gear 223 drives the rotor of the micro electric generator 23 coaxially fixed with the passive gear 223 to rotate.

Module 23: It is a micro electric generator, which is micro DC generator, for converting the kinetic energy generated by the kinetic energy generating module 21 into electric energy, and an output terminal of the micro electric generator is connected to an input terminal of the voltage regulation module 24 by a conductive wire.

Since the passive gear 223 of the kinetic energy transmitting module 22 is coaxially fixed with the rotor of the micro electric generator 23, therefore when the active gear 221 of the kinetic energy transmitting module 22 is rotated, an axle of the micro electric generator 23 is rotated accordingly. In other words, the kinetic energy transmitting module 22 transmits the kinetic energy to the micro electric generator 23, and the rotor of the electric generator 23 is rotate to generate electric energy and the electric energy is outputted to the voltage regulation module 24.

Module 24: It is a voltage regulation module comprised of corresponding basic electronic components such as inductors, capacitors, diodes and triodes and provided for receiving and storing electric energy generated by the micro electric generator 23.

In another preferred embodiment of the present invention, the voltage regulation module 24 generates a constant voltage such as 5V and supplies the voltage to an electronic device such as the mobile phone for a battery charge.

Module 25: It is a power management module for controlling the battery charge of an electric energy generating apparatus of an electronic device or directly supplying electric power to the electronic device for its operation. When the battery level is low and insufficient to support the required power supply of the electronic device, the output terminal of the voltage regulation module 24 is connected to a power input terminal of the electronic device.

A mobile phone is used as an example for illustrating the practical application of the electric energy generating apparatus in a portable or mobile electronic device as follows.

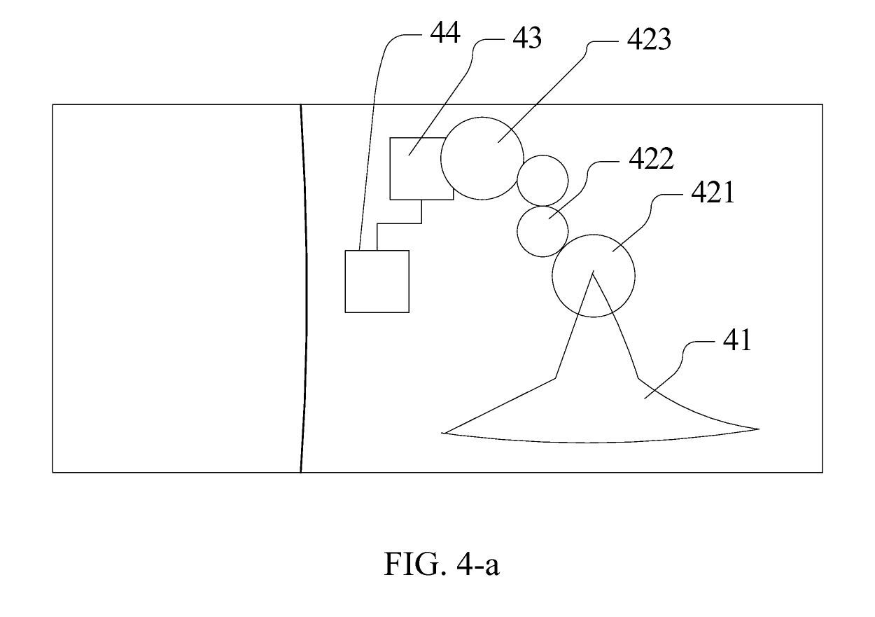

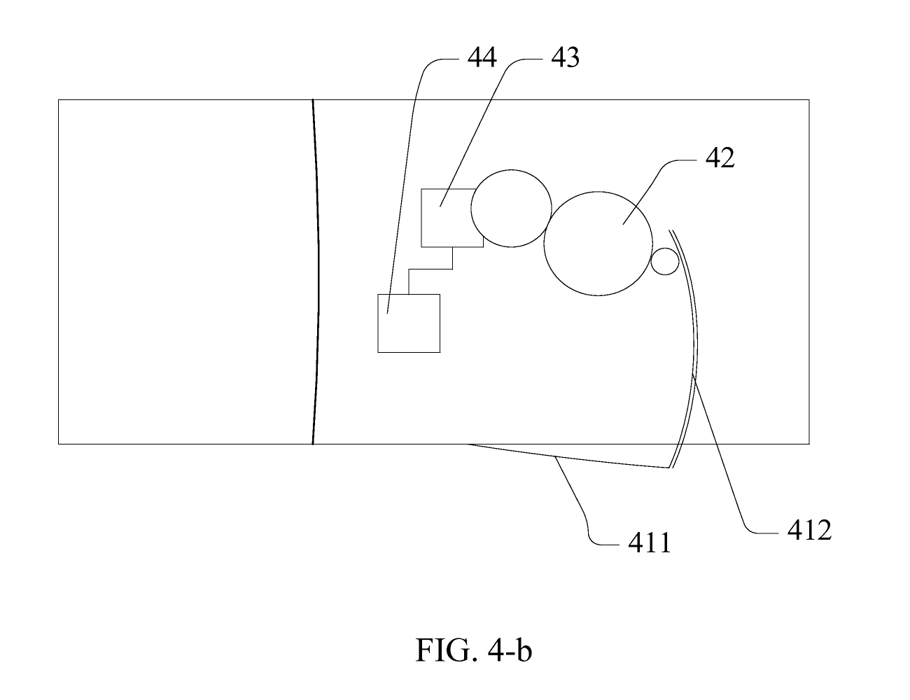

With reference to FIG. 4-a for a schematic structural diagram of a mobile phone in accordance with a first preferred embodiment of the present invention, the mobile phone comprises an electric energy generating apparatus, and the apparatus comprises the following modules:

Module 41: It is a pendulum with a structure including a fixed end, and a suspending end with larger mass. The pendulum is drooped vertically by the gravitation when it is in a still state. The suspending end swings with respect to the fixed end to generate kinetic energy.

If a user carrying an electronic device equipped with the electric energy generating apparatus is walking or shaking the electronic device, the pendulum will swing sideway by the kinetic energy in different directions as well as the gravitational force.

Module 42: It is a gear transmission module for transmitting the kinetic energy generated by the pendulum 41 to the micro electric generator 43. Thus, the kinetic energy can be converted into electric energy by the micro electric generator 43.

Module 43: It is a micro electric generator for converting the kinetic energy generated by the pendulum 41 into electric energy. An output terminal of the micro electric generator is connected to an input terminal of the voltage regulation module 44 by a conductive wire.

Since the passive gear 423 of the gear transmission module 42 is coaxially fixed with the rotor of the micro electric generator 43, therefore when the gear transmission module 42 is rotated, an axle of the micro electric generator 43 is driven to rotate. In other words, the gear transmission module 42 will transmit the kinetic energy to the micro electric generator 43, and the rotor of the micro electric generator 43 will be rotated to generate electric energy, and the electric energy will be outputted to the voltage regulation module 44.

Module 44: It is a voltage regulation module for generating a constant voltage such as 5V for controlling an electric energy generating apparatus such as charging a battery of a mobile phone, or if the battery is low, a base band of the mobile phone is driven directly to operate.

The gear transmission module 42 further comprises the function of switching a direction and controlling a speed of the rotor of the micro electric generator 43, and a slide slot (not shown) is formed on the fixed axle of the transmission gear directly engaged with the active gear. Thus, when the pendulum swings sideway, the transmission gear is driven to move in the slide slot to engage different gears. If the pendulum 41 is rotated clockwise, the active gear 421 is driven to rotate clockwise. Now, the transmission gear 422 engaged with the active gear 421 is engaged directly with the passive gear 423 to drive the passive gear 423 to rotate clockwise. If the pendulum swings counterclockwise, the active gear 421 is driven to rotate counterclockwise. Now, the transmission gear 422 engaged with the active gear 421 slides in the slide slot to release the engagement with the passive gear 423, such that the transmission gear 422 is engaged with another transmission gear, and then engaged with the passive gear 423 again to drive the passive gear 423 to rotate clockwise.

If a user carries a mobile phone or shakes the a mobile phone during walking, the motion of the pendulum generates kinetic energy, and the kinetic energy going through two mechanical direction changing mechanisms to change the direction twice is changed to one direction, and the gear transmission module 42 can use different numbers of transmission gears to switch the direction according to the required moving direction.

The faster the rotating speed, the closer is the speed to the normal rated rotating speed of the electric generator, and the higher is the output voltage of the electric generator. In the process of transmitting kinetic energy by the gear transmission module 42, gears of different sizes can be adopted, and the number of the gears can be increased to speed up the rotation of the rotor. The rotating speed is preferably equal to the normal rated rotating speed of the rotor to assure the micro electric generator to have a normal output of electric energy.

With reference to FIG. 4-b for a schematic structural diagram of a mobile phone in accordance with a second preferred embodiment of the present invention. The mobile phone comprises an electric energy generating apparatus, and the apparatus comprises the following modules:

Module 41: It is a kinetic energy generating module for generating kinetic energy, and comprises a hand-pressing handle 411 and an arc rack 412, wherein an end of the hand-pressing handle 411 is fixed to an end of the arc rack 412, and the arc rack 412 is engaged with the active gear of the gear transmission module 42.

The hand-pressing handle 411 can be moved up and down to drive the arc rack 412 to move up and down in order to generate kinetic energy.

Module 42: It is a gear transmission module for transmitting the kinetic energy generated by the kinetic energy generating module 41 to the micro electric generator 43.

Thus, the kinetic energy can be converted into electric energy by the micro electric generator 43.

When the hand-pressing handle 411 drives the arc rack 412 to move up and down, the active gear engaged with the arc rack 412 is rotated accordingly, and the engaged transmission gear drives the rotor of the micro electric generator 43 coaxially fixed with the passive gear to rotate.

Module 43: It is a micro electric generator for converting the kinetic energy generated by the kinetic energy generating module 41 into electric energy, and an output terminal of the micro electric generator is coupled to an input terminal of the voltage regulation module 44 by a conductive wire.

Module 44: It is a voltage regulation module for receiving and storing electric energy generated by the micro electric generator 43, and generating a constant voltage such as 5V to charge a battery of a mobile phone or supply electric power for the operation of the mobile phone.

The apparatus for converting kinetic energy into electric energy and the mobile electronic device in accordance with the present invention are described in details as above. While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mobile electronic device equipped with an electric energy generating apparatus, wherein the electric energy generating apparatus comprises :
a kinetic energy generating module for generating kinetic energy;
a kinetic energy transmission module;
an electric generator, wherein the kinetic energy transmission module is used for transmitting the kinetic energy to the electric generator, and the electric generator is used for converting the kinetic energy into electric energy; and
a voltage regulation module for regulating the electric energy to a voltage and outputting the voltage.

2. The electronic device of claim 1, wherein the kinetic energy transmission module comprises:
an active gear fixed coaxially with the kinetic energy generating module;
a passive gear fixed coaxially with a rotor of the electric generator; and
a transmission mechanism for transmitting a motion of the active gear to the passive gear.

3. The electronic device of claim 2, wherein the kinetic energy generating module is a pendulum with an end coaxially fixed with the active gear of the kinetic energy transmission module, and the other end suspended and swung with respect to the fixed end to generate the kinetic energy.

4. The electronic device of claim 3, wherein the transmission mechanism comprises at least one transmission gear.

5. The electronic device of claim 4, wherein the passive gear is rotated in a direction determined by a number of the transmission gears, and a rotor of the electric generator is rotated at a speed determined by the size of the active gear, the transmission gear and the passive gear, such that when the pendulum swings in a direction, an even number of the transmission gears is used for transmitting the kinetic energy, so that the active gear and the passive gear are rotated in the same direction, and when the pendulum swings in the other direction, an odd number of the transmission gears is used for transmitting the kinetic energy, so that the active gear and the passive gear are rotated in opposite directions.

6. The electronic device of claim 2, wherein the transmission mechanism comprises a belt.

7. The electronic device of claim 1, wherein the electric energy generating apparatus further comprises a power management module for controlling a component connected to an output terminal of the voltage regulation module, such that when it is necessary to charge a battery component of the electronic device, the output terminal of the voltage regulation module is connected to an electrode of the battery;
when the electronic device requires a power supply for its operation, the output terminal of the voltage regulation module is connected to a power input terminal of the electronic device.

8. The electronic device of claim 7, wherein the electronic device is a mobile phone, and the voltage regulation module has an output voltage value of 5 volts.

9. An electric energy generating apparatus, comprising:
a kinetic energy generating module, for generating a kinetic energy;
a kinetic energy transmission module;
an electric generator, wherein the kinetic energy transmission module is used for transmitting the kinetic energy to the electric generator; and the electric generator is used for converting the kinetic energy into an electric energy; and
a voltage regulation module, for regulating the electric energy to a voltage and outputting the voltage.

10. The electric energy generating apparatus of claim 9, wherein the kinetic energy transmission module comprises
an active gear fixed coaxially with the kinetic energy generating module;
a passive gear fixed coaxially with a rotor of the electric generator; and
a transmission mechanism for transmitting a motion of the active gear to the passive gear.

11. The electric energy generating apparatus of claim 10, wherein the kinetic energy generating module is a pendulum with an end coaxially fixed with the active gear of the kinetic energy transmission module, and the other end suspended and swung with respect to the fixed end to generate a kinetic energy.

12. The electric energy generating apparatus of claim 11, wherein the transmission mechanism comprises at least one transmission gear, and the passive gear is rotated in a direction determined by the number of the transmission gears, and a rotor of the electric generator is rotated at a speed determined by the size of the active gear, the transmission gear and the passive gear, such that when the pendulum swings in a direction, an even number of the transmission gears is used for transmitting the kinetic energy, so that the active gear and the passive gear are rotated in the same direction, and when the pendulum swings in the other direction, an odd number of the transmission gears is used for transmitting the kinetic energy, so that the active gear and the passive gear are rotated in opposite directions.

13. The electric energy generating apparatus of claim 9, further comprising a power management module for controlling components connected to an output terminal of the voltage regulation module, such that when a battery of the electronic device requires a battery charge, the output terminal of the voltage regulation module is connected to an electrode of the battery, and when the electronic device requires a power supply for its operation, the output terminal of the voltage regulation module is connected to an input terminal of the power source of the electronic device.
